(19) United States
(12) Patent Application Publication
(10) Pub. No.: US 2020/0036945 A1
(43) Pub. Date: Jan. 30, 2020

(54) Neighborhood Proximity Media Capture For Life Safety Alarm Events

(71) Applicant: Comcast Cable Communications, LLC, Philadelphia, PA (US)

(72) Inventor: Matthew Vincent Thanner, Austin, TX (US)

(21) Appl. No.: 16/043,492

(22) Filed: Jul. 24, 2018

(51) Int. Cl. H04N 7/18; G06F 17/30; G08B 13/196

(52) U.S. Cl. CPC H04N 7/188; G06F 17/30604; G08B 13/19645; H04N 7/181; G06F 17/30312

(57) ABSTRACT

A central monitoring system may improve the reliability of a plurality of premises monitoring systems in connection with the central monitoring system. The premises monitoring systems may comprise one or more monitoring devices (e.g., cameras, video cameras, smoke detectors) and may operate independently of each other. Based on a monitoring device of a first premises monitoring system detecting an alarm condition at a first premises, the central monitoring system may be configured to activate one or more monitoring devices of a second premises monitoring system in order to improve the chance of capturing media content such as image or video data associated with the alarm condition at the first premises.

### BACKGROUND

A premises monitoring system may comprise one or more devices such as cameras, video cameras, motion sensors, smoke detectors, flood detectors, sprinkler systems, or any other device capable of monitoring for one or more conditions at a location of the premises monitoring system. These devices may be known as monitoring devices or surveillance devices. In the event of an alarm condition such as a burglary, a premises monitoring system may be configured to activate a camera or a video camera in order to capture images or video of the alarm condition. However, the monitoring devices may not always be in an optimal location for detecting or capturing data associated with the alarm conditions. A video camera located near the front door of a premises may not be capable of capturing video of a burglar who enters through a window in a back room of that premises.

### SUMMARY

A central monitoring system is disclosed for improving the reliability of a plurality of premises monitoring systems in connection with the central monitoring system. The premises monitoring systems may comprise one or more monitoring devices (e.g., cameras, video cameras, smoke detectors) and may operate independently of each other. Based on a monitoring device of a first premises monitoring system detecting an alarm condition at a first premises, the central monitoring system may be configured to activate one or more monitoring devices of a second premises monitoring system in order to improve the chance of capturing media content such as image or video data associated with the alarm condition at the first premises.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 is a block diagram of an example system;

FIG. 2 is a diagram of an example burglary scenario;

FIG. 3 is a flow chart of an example method;

FIG. 4 is a flow chart of an example method;

FIG. 5 is a flow chart of an example method; and

FIG. 6 is a block diagram of an example computing device.

### DETAILED DESCRIPTION OF ILLUSTRATIVE EMBODIMENTS

Systems and methods are disclosed for improving the capabilities of one or more premises monitoring systems. The premises monitoring systems may be in communication with a central monitoring system configured to associate data received from each of the premises monitoring systems in order to improve the likelihood of capturing data associated with an event or an alarm condition. Each of the premises monitoring systems may comprise one or more monitoring devices, such as a camera, a video camera, a motion sensor, a smoke detector, a flood detector, a sprinkler system, or any other device configured to maintain the safety of the location where the premises monitoring system is located.

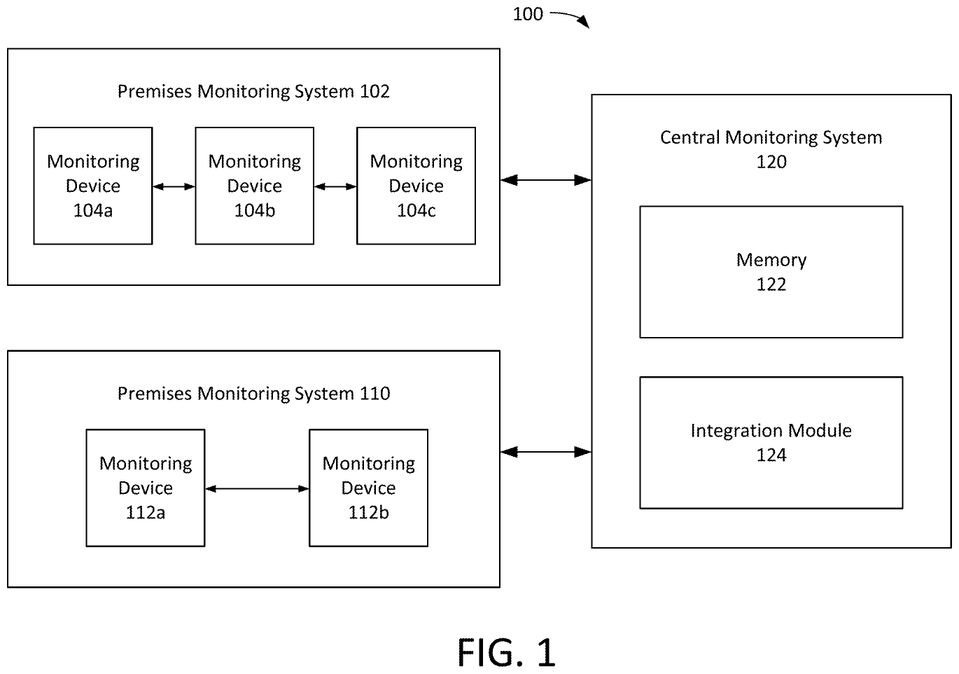

FIG. 1 shows a system 100 for improved premises monitoring. The system 100 may comprise a premises monitoring system 102, a premises monitoring system 110, and a central monitoring system 120. While FIG. 1 shows a central monitoring system 120 in communication with two premises monitoring systems, it is understood that the central monitoring system 120 may be in communication with any number of premises monitoring systems.

The premises monitoring system 102 may be configured to manage one or more monitoring devices 104 associated with the premises monitoring system 102. The one or more monitoring devices 104 may be configured to monitor for one or more conditions at a location of the premises monitoring system 102. Example locations of premises monitoring systems may include, for example, a household, an apartment, a condominium, a business, a warehouse, or any location where it may be desirable to monitor for one or more conditions using one or more monitoring devices 104. These locations may be referred to herein as “premises.”

The monitoring devices 104 may be configured to monitor for one or more conditions such as a burglary at the premises (e.g., inside or outside of the premises), a fire at the premises, the presence of smoke in the premises, a medical emergency at the premises, a flood in the premises, a temperature change in the premises, activation of a panic alarm at the premises, a gas leak (e.g., carbon monoxide) at the premises, loss of air flow at the premises, low water pressure at the premises, battery failure in one or more of the monitoring devices 104, and communication troubles to or from the premises. It is understood that the conditions listed above are example conditions only and that any type condition may be monitored for by a given one of the monitoring devices 104.

An example monitoring device 104 may be, for example, a camera, a video camera, a microphone, a motion sensor, a smoke detector, a flood detector, a sprinkler system, a temperature detector, or a gas detector. However, it is understood that the monitoring device 104 may be any type of monitoring device that is capable of monitoring for one or more conditions and maintaining the safety of the location where the premises monitoring system 102 is located. It is also understood that the premises monitoring system 102 may comprise multiple different types of monitoring devices 104. For example, the monitoring device 104a may be a camera, the monitoring device 104b may be a motion sensor, and the monitoring device 104c may be a smoke detector. While FIG. 1 shows a premises monitoring system 102 comprising three monitoring devices 104, it is understood that premises monitoring system 102 may comprise any number of monitoring devices 104.

The monitoring devices 104 may be configured to communicate with one another. For example, monitoring device 104a may be configured to communicate with any of monitoring devices 104b and 104c. Monitoring device 104a may be a motion sensor configured to activate a camera 104b or a video camera 104c based on a detected motion at the premises. The monitoring devices 104 may additionally or alternatively be in communication with one or more other types of devices, such an alarm system that automatically generates an alert in based on motion being detected by the monitoring device 104. It is understood that a given monitoring device may be configured to monitor for more than one type of monitored condition. For example, a camera or video camera may comprise motion sensing capabilities and a smoke detector may comprise carbon monoxide detecting capabilities.

The monitoring devices 104 may be configured to capture data associated with the one or more monitored conditions. For example, the monitoring devices 104 may be configured to capture media content such as images, videos, audio, or any indication that one or more conditions to be monitored for has been detected, such as an indication that smoke has been detected, an indication that a flood has been detected, an indication of a temperature change, and an indication that a gas leak has been detected. The monitoring devices may additionally or alternatively be configured to capture information associated with the monitored conditions, such as a location of a detected condition, a time that the condition was detected, and/or one or more characteristics of the detected condition. In one example, the information may be metadata associated with the image, video or audio data captured by the monitoring devices 104. The information may be stored by one or more of the premises monitoring system 102, the central monitoring system 120, or a remote server in communication with the premises monitoring system 102 and/or the central monitoring system 120.

The premises monitoring system 110 may be similar to the premises monitoring system 102. While the premises monitoring system 110 is shown in FIG. 1 as comprising two monitoring devices 112a and 112b, it is understood that the premises monitoring system 110 may comprise any number of monitoring devices.

The premises monitoring system 102 and the premises monitoring system 110 may be configured to send the information captured by any of the monitoring devices 104 or 112 to the central monitoring system 120. For example, the premises monitoring system 102 may be configured to send information associated with the intrusion to the central monitoring system 120, such as a time of the intrusion and a location of the premises monitoring system 102). The premises monitoring systems 102 and 110 may additionally or alternatively send to the central monitoring system 120 data captured by the monitoring devices, such as one or more images captured by a camera 102.

The central monitoring system 120 may be configured to receive, as input from the plurality of premises monitoring systems 102 and 110, the information associated with the detection of a monitored condition. The central monitoring system 120 may comprise a memory 122 and an integration module 124.

The memory 122 of the central monitoring system 120 may be configured to store information received from the premises monitoring system 102 and the premises monitoring system 110. The memory 122 of the central monitoring system 120 may receive from the premises monitoring system 102 information associated with data captured from one or more of the monitoring devices 104a, 104b and 104c, and may be configured to store this data at the central monitoring system 120. Additionally or alternatively, the memory 122 may receive from the premises monitoring system 110 information associated with data captured from one or more of the monitoring devices 112a and 112c, and may be configured to store this data at the central monitoring system 120. The memory 122 may be configured to receive and to store data captured by any of the monitoring devices 104 and 112, such as images, videos and audio.

The integration module 124 may be configured to associate data received from the premises monitoring system 102 with data received from the premises monitoring system 110. The integration module 124 may determine, that data captured by the monitoring devices 104 may be relevant to the premises monitoring system 110. This determination may be based, for example, on identifiers associated with the premises monitoring systems 102 and 110 such as an account premise identifier and/or a location of the premises monitoring systems 102 and 110. However, it is understood that this determination may be made manually or automatically based on any number of factors.

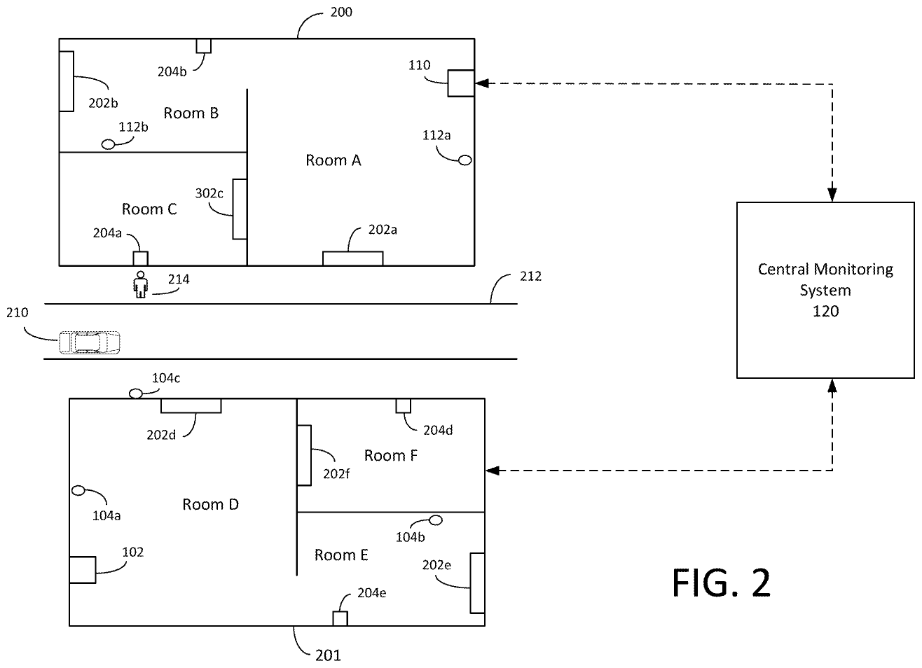

FIG. 2 shows an example use case of a home invasion involving a first premises 200 and a second premises 201. In a first example, at least one of the premises 200 or the premises 201 may not be associated with a central monitoring system, such as the central monitoring system 120. In a second example, both the premises 200 and the premises 201 are associated with the central monitoring system 120.

The premises 200 may be a household located on a first side of a street 212. The premises 200 may comprise three rooms shown in the figure as Room A, Room B and Room C, two exterior doors shown in the figure as 202a and 202b, an interior door shown in the figure as 202c, and two windows shown in the figure as 204a and 204b. The first premises may further comprise a premises monitoring system 110. The premises monitoring system 110 may be associated with two interior monitoring devices shown in the figure as 112a and 112b. In this example, the monitoring devices may comprise one or more of a camera, a video camera and a motion sensor. The monitoring device 112a may be configured to detect motion and/or capture images or video in the area of the door 202a. The monitoring device 112b may be configured to detect motion and/or capture images or video in the area of the door 202b.

In premises 200, each of Room A, Room B and Room C may be separated by a wall. Thus, the monitoring device 112a may only be able to capture data associated with Room A, and the monitoring device 112b may only be able to capture data associated with Room B. Room C of premises 200 may not comprise a monitoring device.

The premises 201 may be a household located on a second side of a street 212. The premises 201 may comprise three rooms shown in the figure as Room D, Room E and Room F, two exterior doors shown in the figure as 202d and 202e, an interior door shown in the figure as 202f, and two windows shown in the figure as 204d and 204e. The premises 201 may further comprise a premises monitoring system 102. The premises monitoring system 102 may be associated with two interior monitoring devices shown in the figure as 104a and 104b. The premises monitoring system may further be associated with an exterior monitoring device 104c. The monitoring device 104a may be configured to detect motion and/or capture images or video in the area of the door 202d. The monitoring device 104b may be configured to detect motion and/or capture images or video in the area of the door 202e. The monitoring devices may comprise one or more of a camera, a video camera and a motion sensor.

In premises 201, each of Room D, Room E and Room F may be separated by a wall. Thus, the monitoring device 104a may only be able to capture data associated with Room D, and the monitoring device 104b may only be able to capture data associated with Room E. Room F may not comprise a monitoring device. The monitoring device 104c may be located outside the premises 201 and may be configured to capture data outside of the premises 201, such as on the street or on a porch of the premises 201.

In a first example burglary scenario, each of the premises monitoring systems 102 and 110 may operate independently of one another. Neither the premises monitoring system 102 nor the premises monitoring system 110 may send any data to the central monitoring system 120. Burglar 214 may enter premises 200 through window 204a. The burglar 214 may enter Room C (e.g., a bedroom), take personal property (e.g., money and jewelry) and leave through the same window 204a. Because there is no monitoring device associated with Room C of premises 200, the burglar may get away with the stolen property without being captured by any of the monitoring devices 112a or 112b. In addition, the burglar may enter Room A (e.g., a family room) and take additional personal property (e.g., electronics) belonging to the homeowner. Even if the motion sensor 112a detected that the burglar 214 was in the room and generated an alarm, a camera associated with the motion sensor 112a may not be able to capture image or video data of the burglar 214 as the burglar did not enter or exit through door 202a. While monitoring device 104c associated with premises 201 may have a view of the burglar 214 walking towards and away from the premises 200 and/or towards and away from the car 210, the monitoring device 104c may not record any information associated with the burglary as there was no intrusion detected at premises 201 and the premises monitoring system 102 is unaware of the intrusion at premises 200.

In a second burglary scenario, assume that motion sensor 112a in premises 200 detected that the burglar 214 was in Room A and generated an alarm. However, the camera associated with the motion sensor 112a was not able to capture image or video data of the burglar 214 as the burglar did not enter or exit through door 202a. The burglar 214 may leave the premises 200 through the window 204a, get in car 210 and drive away without any image or video data being captured by premises monitoring system 110. In the second burglary scenario, both the premises 200 and the premises 201 are connected to the central monitoring system 120. Thus, the premises monitoring system 110 in the premises 200 may send to the central monitoring system 120 an indication that an intrusion has been detected. The central monitoring system 120 may be configured to send to the premises monitoring system 102 an indication to activate one or more of the monitoring devices associated with the premises monitoring system. Specifically, the central monitoring system 120 may send to the premises monitoring system 110 an instruction to activate monitoring device 104c, which may capture data of the burglar 214 entering and exiting the car 210, walking across the street 212 and entering the window 204a of the premises 200. This data may later be accessed by the central monitoring system 120 and/or the premises monitoring system 102, thus improving the functionality of the premises monitoring systems.

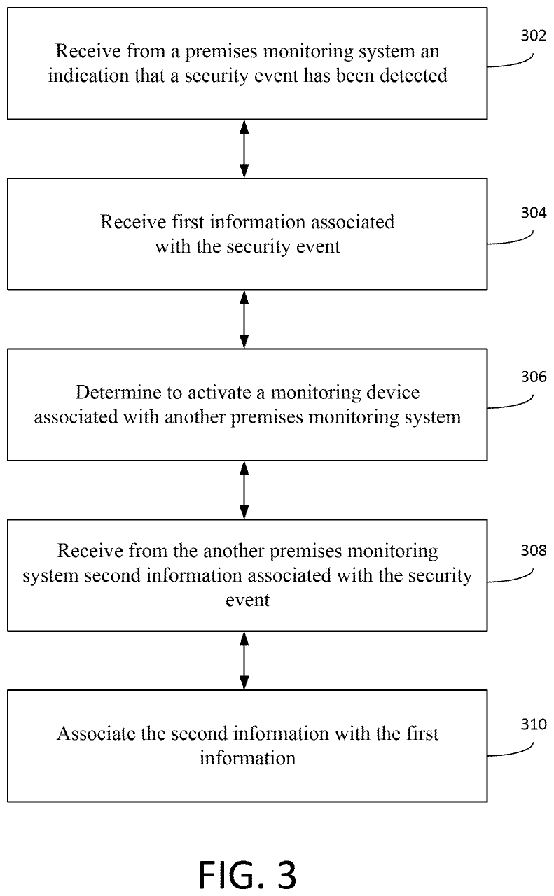

FIG. 3 shows an example method in accordance with an aspect of the disclosure. At step 302, an indication that an event has been detected may be received. The indication may be received from a premises monitoring system, such as the premises monitoring system 102 shown in FIG. 1. The indication may be received at a central monitoring system, such as the central monitoring system 120 shown in FIG. 1. An event may comprise, for example, a burglary or fire at a premises where the premises monitoring system is located. However, it is understood that an event may comprise a detection of any condition capable of being monitored by a monitoring device of the premises monitoring system.

The premises monitoring system may comprise a plurality of monitoring devices, such as the monitoring devices 102 shown in FIG. 1. The monitoring devices may be, for example, a camera, a video camera, a motion sensor, a smoke detector, a flood detector, a sprinkler system, or any type of monitoring device that is capable of detecting or monitoring for one or more conditions. The premises monitoring system may comprise more than one type of monitoring device, such as a camera, video camera, and a smoke detector, and/or may comprise multiple of the same types of monitoring devices, such as three cameras.

At step 304, first information associated with the event may be received. The first information may be received from the premises monitoring system. The first information may be associated with media content captured from a monitoring device of the premises monitoring system, such as image or video data. In one example, the information may comprise metadata associated with the data captured from the monitoring device. The first information may comprise, for example, an indication that the event was detected, an identifier of the event, an indication of the type of event that was detected, an indication of the severity of the event, a location of the premises, the time the event was detected, the type of data that was captured by the monitoring device, and/or one or more characteristics of the data that was captured by the monitoring device. However, it is understood that the information may comprise any type of data associated with the event. Additionally or alternatively, data such as image or video data captured by a monitoring device of the premises monitoring system may be received and stored by the central monitoring system.

At step 306, it may be determined to activate another monitoring device associated with another premises monitoring system. The another premises monitoring system may be, for example, premises monitoring system 110 shown in FIG. 1. The another premises monitoring system may be located at a location different from the location of the premises monitoring system. The determination to activate the another monitoring device may be based on a location of one or more other premises monitoring systems and/or an identifier of one or more other premises monitoring systems. The central monitoring system may be able to determine, based on a location of the premises monitoring system and a location of one or more other premises monitoring systems, that one or more of the other premises monitoring systems may be able to capture data associated with the premises of the premises monitoring system. However, it is understood that the determination to activate the another premises monitoring system may additionally or alternatively be based on other information associated with at least one of the premises monitoring system or the another premises monitoring system, such as an identifier of the premises monitoring system and the another premises monitoring system.

The premises monitoring system and the another premises monitoring system may be associated with the central monitoring system. The premises monitoring system may be associated with a first subscriber of the central monitoring system and the another premises monitoring system may be associated with another subscriber of the central monitoring system. For example, the central monitoring system may be operated by a cable provider. The premises monitoring system may be a first customer of the cable provider and the another premises monitoring system may be a second customer of the cable provider.

The central monitoring system may send to the another premises monitoring system an indication to activate the another monitoring device. The central monitoring system may send to the another premises monitoring system an indication to “turn on” or activate all monitoring devices associated with the premises monitoring system. Additionally or alternatively, the central monitoring system may send to the another premises monitoring system an indication to activate select monitoring devices, such as only those with a view of the premises where the premises monitoring system is located. The another premises monitoring system may comprise one or more different types of devices than the premises monitoring system. For example, the another premises monitoring system may comprise a video camera while the premises monitoring system comprises only still-image capturing cameras.

At step 308, second information may be received from the another premises monitoring system. The second information may be associated with data captured by the another monitoring device. The second information may be associated with at least one of image or video data of the event captured by the another monitoring device. The second information may comprise, for example, an indication that the event was detected, an identifier of the event, an indication of the type of event that was detected, a location of the premises associated with the another premises monitoring system, the time the data was captured by the another premises monitoring system, the type of data that was captured by the monitoring device associated with the another premises monitoring system, and/or one or more characteristics of the data that was captured by the monitoring device of the another premises monitoring system. However, it is understood that the information may comprise any type of data associated with the event. Additionally or alternatively, data such as image or video data captured by a monitoring device of the another premises monitoring system may be received and stored by the central monitoring system. The another premises monitoring system may be located at a second location that is different from the first location of the premises monitoring system. For example, the premises monitoring system may be associated with a first household on a street while the another premises monitoring system may be associated with a second household on the same street.

At step 310, the second information may be associated with the first information. The first information may comprise first context information associated with the event and the second information may comprise second context information associated with the event. For example, the first information may comprise a first view of a security event and the second information may comprise a second view of the security event. The central monitoring system may automatically associate the second information with the first information as a result of sending to the another premises monitoring system the indication to activate one or more monitoring devices associated with the another premises monitoring system. Additionally or alternatively, the central monitoring system may determine that the second information is related to the first information based on one or more characteristics of the first information and one or more characteristics of the second information. For example, the central monitoring system may determine that the first information was captured at approximately the same time as the second information and that the location of the premises monitoring system is in close proximity to the location of the another premises monitoring system.

An identifier associated with the first information may be stored with an identifier associated with the second information. Thus, when the first information is accessed using the identifier associated with the first information, the second identifier may also be identified such that the second information is accessed along with the first information.

The event, also known as an alarm condition, may be associated with an identifier. The central monitoring system may be configured to associate both the first information and the second information with the identifier associated with the alarm condition. Thus, if a lookup is performed for the identifier associated with the alarm condition, both the first information and the second information may be accessed.

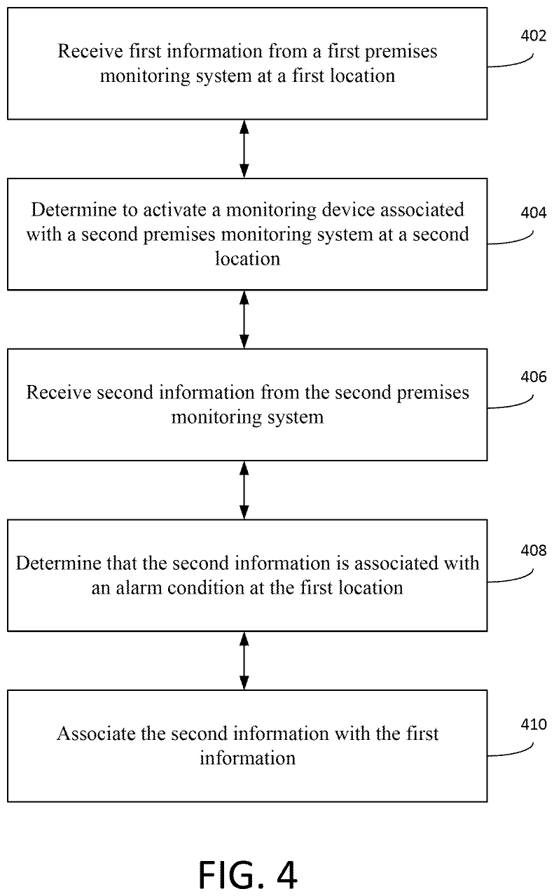

FIG. 4 shows an example method in accordance with an aspect of the disclosure. At step 402, first information may be received. The first information may be received from a first premises monitoring system located at a first location, such as the premises monitoring system 102 shown in FIG. 1. The first information may be received at a central monitoring system, such as the central monitoring system 120 shown in FIG. 1. The first information may be associated with data captured by a monitoring device of the first premises monitoring system, such as the monitoring device 104 shown in FIG. 1. The first information may comprise, for example, an indication that an alarm condition was detected, an identifier of the alarm condition, an indication of the type of alarm condition that was detected, an indication of the severity of the alarm condition, an indication of the first location of the first premises monitoring system, the time the alarm condition was detected, the type of data that was captured by the monitoring device, and/or one or more characteristics of the data that was captured by the monitoring device. However, it is understood that the information may comprise any type of data associated with the alarm condition. Additionally or alternatively, media content such as image or video data captured by the monitoring device of the first premises monitoring system may be received and stored by the central monitoring system.

The premises monitoring system may comprise a plurality of monitoring devices, such as the monitoring devices 104a, 104b and 104c shown in FIG. 1. The monitoring devices may comprise, for example, a camera, a video camera, a motion sensor, a smoke detector, a flood detector, a sprinkler system, or any type of monitoring device that is capable of detecting or monitoring for one or more conditions. The premises monitoring system may comprise more than one type of monitoring device, such as a camera, video camera, and a smoke detector, and/or may comprise multiple of the same types of monitoring devices, such as three cameras. The monitoring device of the first premises monitoring system may be configured to capture data based on a detection by the first premises monitoring system of one or more alarm conditions at the first location. The media content may comprise, for example, one or more of image data, video data, and/or audio data. However, it is understood that the data may comprise any type of data associated with a monitored condition. An alarm condition may comprise, for example, a burglary or fire at a premises where the premises monitoring system is located. However, it is understood that an alarm condition may comprise a detection of any condition capable of being monitored by a monitoring device of the premises monitoring system.

At step 404, it may be determined to activate a monitoring device of a second premises monitoring system, such as premises monitoring system 110 shown in FIG. 1. The second premises monitoring system may be located at a second location, such as a household in proximity to the household of the first premises monitoring system. The second premises monitoring system may comprise a plurality of monitoring devices, such as the monitoring devices 112 shown in FIG. 1.

The determination to activate a monitoring device of the second premises monitoring system may be based on the first information. For example, the first information may comprise an indication of a location of the first premises monitoring system. The central monitoring system may be configured to determine, based on the location of a first premises monitoring system, that one or more other premises monitoring systems such as the second premises monitoring system may also be able to capture data associated with the first premises. For example, the central monitoring system may determine that the second premises monitoring system is associated with a household across the street from the household with the first premises monitoring system, and that the second premises monitoring system has an outdoor camera or video camera with a view of the first premises. However, it is understood that the determination to activate the second premises monitoring system may be based on any information associated with the first premises monitoring system or the second premises monitoring system.

The central monitoring system may send to the second premises monitoring system an indication to activate the monitoring device. The central monitoring system may send to the second premises monitoring system an indication to “turn on” or activate all monitoring devices associated with the second premises monitoring system. Additionally or alternatively, the central monitoring system may send to the second premises monitoring system an indication to activate certain monitoring devices, such as only those with a view of the first premises. The second premises monitoring system may comprise different types of devices than the premises monitoring system. For example, the monitoring device of the first premises monitoring system may be a motion sensor and/or alarm system, while the monitoring device of the second premises monitoring system may be a camera or a video camera.

The first premises monitoring system may be associated with a first subscriber of the central monitoring system and the second premises monitoring system may be associated with a second subscriber of the central monitoring system. For example, the central monitoring system may be operated by a cable provider. The first premises monitoring system may be a first customer of the cable provider and the second premises monitoring system may be a second customer of the cable provider. The central monitoring system may determine, prior to activating the monitoring device of the second premises monitoring system, that the monitoring device of the second premises monitoring system is capable of capturing information associated with the one or more alarm conditions at the first location.

At step 406, second information may be received from the second premises monitoring system. The second information may be associated with data captured by the monitoring device of the second premises monitoring system. The second information may comprise, for example, a location of the first premises and/or the second premises, a time the data was captured by the second premises monitoring system, the type of data that was captured by the second premises monitoring system, and/or one or more characteristics of the data that was captured by the second premises monitoring system. The data captured by the monitoring device of the second premises monitoring system may comprise at least one of image or video data associated with the alarm condition at the first premises. However, it is understood that the data captured by the monitoring device of the second premises monitoring system may comprise any type of data associated with the alarm condition at the first premises.

At step 408, it may be determined that at least a portion of the second information is associated with the one or more alarm conditions at the first location. The central monitoring system may be configured to determine, based on the first information and the second information, that the second information is associated with the one or more alarm conditions at the first location. The central monitoring system may determine, based on an identifier of the alarm condition, a location of the first premises monitoring system and the second premises monitoring system, and/or a time of the event, that the second information is associated with the one or more alarm conditions at the first location. Additionally or alternatively, the central monitoring system may determine automatically that the second information is associated with one or more alarm conditions based on sending to the second premises monitoring system an indication to activate the monitoring device of the second premises monitoring system.

At step 410, the second information may be associated with the first information. The central monitoring system may automatically associate the second information with the first information based on sending to the second premises monitoring system the indication to activate one or more monitoring devices associated with the second premises monitoring system. Additionally or alternatively, the central monitoring system may associate the second information with the first information based on determining that at least a portion of the second information is associated with the one or more alarm conditions at the first location. Associating the second information with the first information comprises associating the second information and the first information with an identifier of the event

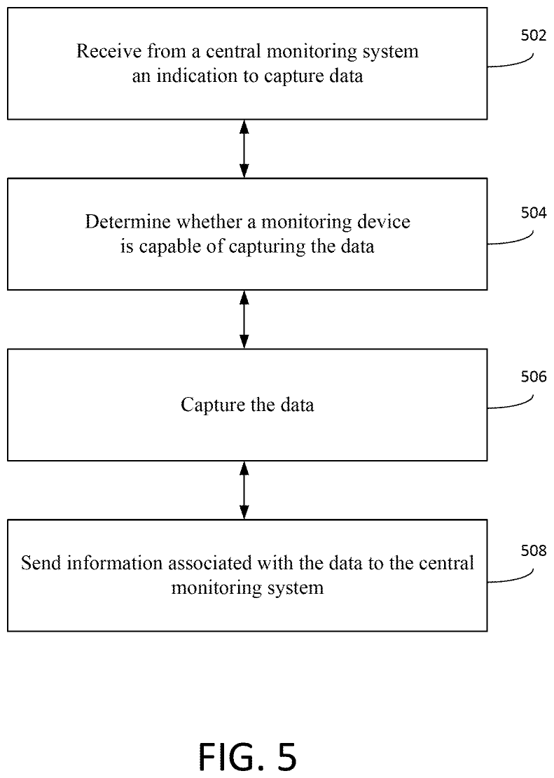

FIG. 5 shows an example method in accordance with an aspect of the disclosure. At step 502, an indication to capture data may be received. The indication may comprise an indication to capture one or more of image or video data. However, it is understood that the indication may comprise an indication to capture any type of data, including but not limited to audio data. The indication may be received at a premises monitoring system, such as premises monitoring system 102 shown in FIG. 1. The indication may be received from a central monitoring system, such as central monitoring system 120.

The central monitoring system may send the indication to the premises monitoring system based on receipt at the central monitoring system from another premises monitoring system that an alarm condition has been detected by a monitoring device associated with the another premises monitoring system. The another premises monitoring system may be, for example, premises monitoring system 110 shown in FIG. 1. The alarm condition may comprise detection of at least one of a burglary or a fire at a premises of the another premises monitoring system. The premises monitoring system may be associated with a subscriber of the central monitoring system and the another premises monitoring system may be associated with another subscriber of the central monitoring system.

The another premises monitoring system may be located at a location different than the location of the premises monitoring system. Each of the premises monitoring system and the another premises monitoring system may comprise a plurality of monitoring devices. In one example, the monitoring device associated with the premises monitoring system may comprise one or more of a camera or a video camera, and the monitoring device associated with the another premises monitoring system may comprise one or more of a camera, a video camera, a motion sensor, a smoke detector, or a flood detector. However, it is understood that the monitoring devices associated with each of the premises monitoring system and the another premises monitoring system may be any type of monitoring device configured for detection of any type of condition. The monitoring device associated with the premises monitoring system may be a different type of monitoring device than the monitoring device associated with the another premises monitoring system.

At step 504, it may be determined whether one or more of the plurality of monitoring devices associated with the premises monitoring system are capable of capturing data associated with the alarm condition at the premises of the another premises monitoring system. The determination of whether one or more of the plurality of monitoring devices associated with the premises monitoring system are capable of capturing data associated with the alarm condition may be based on information associated with the detected alarm condition, the information being received from the central monitoring system. The information associated with the detected alarm condition may comprise, for example, an identifier of the alarm condition, an indication of the type of alarm condition that was detected, a location of the premises associated with the another premises monitoring system, the time the data was captured by the another premises monitoring system, and/or one or more characteristics of the data that was captured by the monitoring device of the another premises monitoring system.

At step 506, the premises monitoring system may capture at least one of image or video data. The premises monitoring system may capture the image or video data based on determining that a monitoring device associated with the premises monitoring system is capable of capturing data associated with the alarm condition. For example, the premises monitoring system may determine that the premises associated with the another premises monitoring system is in proximity to the premises monitoring system and that a monitoring device of the premises monitoring system may be able to capture data associated with the alarm condition at the premises of the another premises monitoring system.

At step 508, the premises monitoring system may send to the central monitoring system information associated with the image or video data. The central monitoring system may be configured to associate the information with information received from the another premises monitoring system. The central monitoring system may automatically associate the information from the premises monitoring system with the information from the another premises monitoring system based on one or more characteristics of the information. Associating the second information with the first information comprises associating the second information and the first information with an identifier of the event.

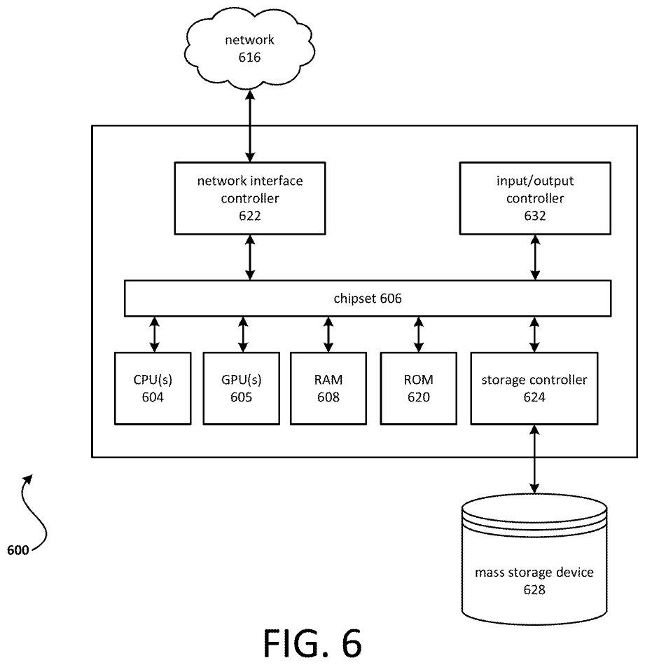

FIG. 6 depicts a computing device that may be used in various aspects, such as the servers, modules, and/or devices depicted in FIG. 1. With regard to the example architecture of FIG. 1, premises monitoring system 102, the monitoring devices 104, the premises monitoring system 110, the monitoring devices 112, and/or the central monitoring system 120 may each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 2-5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A user interface may be provided between the CPU(s) 604 and the remainder of the components and devices on the baseboard. The interface may be used to access a random access memory (RAM) 608 used as the main memory in the computing device 600. The interface may be used to access a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein. The user interface may be provided by a one or more electrical components such as the chipset 606.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a storage device 628 that provides non-volatile storage for the computer. The storage device 628 may store system programs, application programs, other program modules, and data, which have been described in greater detail herein. The storage device 628 may be connected to the computing device 600 through a storage controller 624 connected to the chipset 606. The storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 628 is characterized as primary or secondary storage and the like.

For example, the computing device 600 may store information to the storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the storage device 628 by detecting the physical states or characteristics of one or more particular locations within the physical storage units.

In addition to the storage device 628 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 628 may store other system or application programs and data utilized by the computing device 600.

The storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIGS. 2-5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising
receiving, from a premises monitoring system, an indication that an event has been detected, wherein the premises monitoring system is located at a first premises and is associated with a plurality of monitoring devices;
receiving, from the premises monitoring system, first information associated with the event, wherein the first information is associated with media content captured by a monitoring device of the plurality of monitoring devices;
determining, based on a location of one or more other premises monitoring systems, to activate an other monitoring device associated with an other premises monitoring system, wherein the other premises monitoring system is located at a second premises;
receiving, from the other premises monitoring system, second information associated with media content of the event captured by the other monitoring device from the second premises; and
associating the second information with the first information, wherein the first information comprises first context information associated with the event and the second information comprises second context information associated with the event.

2. The method of claim 1, further comprising storing an identifier of the first information with an identifier of the second information.

3. The method of claim 1, wherein the event comprises at least one of a burglary or a fire at the first premises.

4. The method of claim 1, wherein the monitoring device comprises at least one of a camera, a video camera or a motion sensor.

5. The method of claim 1,
wherein the premises monitoring system and the other premises monitoring system are associated with a central monitoring system, and
wherein the premises monitoring system is associated with a first subscriber of the central monitoring system and the other premises monitoring system is associated with a second subscriber of the central monitoring system.

6. The method of claim 1, further comprising associating the first information and the second information with an identifier of the event.

7. The method of claim 1, further comprising sending, to the other premises monitoring system, an indication to capture media content associated with the event.

8. A method comprising:
receiving, from a first premises monitoring system located at a first location, first information associated with data captured by a monitoring device of a plurality of monitoring devices of the first premises monitoring system, wherein the monitoring device captures the data based on a detection by the first premises monitoring system of one or more alarm conditions at the first location;
determining, based on receiving the first information, to activate a monitoring device of a second premises monitoring system located at a second location, wherein the second premises monitoring system is associated with a plurality of monitoring devices;
receiving, from the second premises monitoring system, second information associated with data captured by a monitoring device of the second premises monitoring system;
determining that at least a portion of the second information is associated with the one or more alarm conditions at the first location; and
associating the second information with the first information, wherein the first information comprises first context information associated with the one or more alarm conditions at the first location and the second information comprises second context information associated with the one or more alarm conditions at the first location.

9. The method of claim 8, further comprising storing an identifier of the first information with an identifier of the second information.

10. The method of claim 8, wherein the first information and the second information are associated with one or more of image data, video data, and audio data.

11. The method of claim 8, wherein:
the monitoring device of the first premises monitoring system is associated with one or more of a camera, a video camera, a motion sensor, a smoke detector, or a flood detector; and
the monitoring device of the second premises monitoring system is associated with one or more of a camera or a video camera.

12. The method of claim 11, wherein the monitoring device of the first premises monitoring system is a different type of device than the monitoring device of the second premises monitoring system.

13. The method of claim 8,
wherein the first premises monitoring system and the second premises monitoring system are associated with a central monitoring system, and
wherein the first premises monitoring system is associated with a first subscriber of the central monitoring system and the second premises monitoring system is associated with a second subscriber of the central monitoring system.

14. The method of claim 8, further comprising associating the first information and the second information with an identifier of the one or more alarm conditions.

15. The method of claim 8, further comprising determining, prior to activating the monitoring device of the second premises monitoring system, that the monitoring device of the second premises monitoring system is capable of capturing data associated with the one or more alarm conditions at the first location.

16. A method comprising:
receiving, at a premises monitoring system from a central monitoring system, an indication to capture media content,
wherein the central monitoring system sends the indication to the premises monitoring system based on receipt at the central monitoring system from an other premises monitoring system that an alarm condition has been detected by a monitoring device of the other premises monitoring system, and
wherein the premises monitoring system is associated with a first premises and the other premises monitoring system is associated with a second premises, each of the premises monitoring system and the other premises monitoring system being associated with a plurality of monitoring devices;
determining, at the premises monitoring system, whether one or more of the plurality of monitoring devices of the premises monitoring system are capable of capturing data associated with the alarm condition at the second premises;
capturing, based on determining that a monitoring device of the premises monitoring system is capable of capturing data associated with the alarm condition at the second premises, media content; and
sending, to the central monitoring system, information associated with the media content,
wherein the central monitoring system is configured to associate the information with information received from the other premises monitoring system, and
wherein the information sent to the central monitoring system comprises first context information associated with the alarm condition and the information received from the other premises monitoring system comprises second context information associated with the alarm condition.

17. The method of claim 16, further comprising storing, with an identifier associated with the first information, an identifier associated with the second information.

18. The method of claim 16, wherein the alarm condition comprises at least one of a burglary or a fire at the second premises.

19. The method of claim 16, wherein the premises monitoring system is associated with a first subscriber of the central monitoring system and the other premises monitoring system is associated with a second subscriber of the central monitoring system.

20. The method of claim 16, wherein:
the monitoring device associated with the premises monitoring system is associated with one or more of a camera or a video camera; and
the monitoring device associated with the other premises monitoring system is associated with one or more of a camera, a video camera, a motion sensor, a smoke detector, or a flood detector.
